(19) United States
(12) Patent Application Publication
(10) Pub. No.: US 2011/0198406 A1
(43) Pub. Date: Aug. 18, 2011

(54) Vapor/vacuum heating system

(76) Inventor: Igor Zhadanovsky, Newton, MA (US)

(21) Appl. No.: 12/984,468

(22) Filed: Jan. 4, 2011

Related U.S. Application Data
(60) Provisional application No. 61/338,341, filed on Feb. 18, 2010.

(51) Int. Cl. F24D 1/00; B60H 1/00

(52) U.S. Cl. 237/12; 237/2 A

(57) ABSTRACT

A building heating system with cycling steam source used for plurality of radiators is provided. During heating cycle condensate is retained in radiators and released later through steam supply line. Such condensate and steam flows alternation eliminates water hammering and justify usage of smaller diameter tubes and new radiator design. When air is evacuated, system operates like branched heat pipe with periodic condensate return. System may include vacuum check valve on air vent lines and operational procedure to create vacuum naturally by steam condensing in a closed space after complete air purging from the system. Steam/vapor source's cut off pressure can be adjusted to regulate the vapor's temperature depending on the outside temperature. Method is proposed for conversion of the existing steam heating systems into a vapor/vacuum system with naturally induced vacuum.

### FIELD

The presented invention relates to methods and devices for heating a space using a vapor/vacuum-based heating system.

### BACKGROUND

Steam-based heating systems provide simple and reliable techniques for heating in a wide variety of industrial, commercial, and residential applications; system has no moving parts, making for easy to maintain and giving it a longer life span.

Water (as a liquid) heated in a boiler becomes steam (a gas), which then rises through the pipes and condenses in radiators, giving off its latent heat. Radiators become hot and heat up objects in the room directly as well as the surrounding air. Steam is delivered under the low pressure of up to 2 psig at 218° F. in order to improve boiler safety and efficiency, also steam at lower pressure moves faster, contain less water and doesn't create boiler low water problems. The boiler creates initial pressure to overcome pipes friction.

Traditionally, steam heating radiators are equipped with normally opened vent valves. When the heating cycle starts, steam raises to radiators through heating lines and push air out till shutting off vent valves. When the boiler stops, radiators cool down and vent valves reopen to let air in, as steam condensation within a system creates vacuum.

Temperature control for steam systems typically includes a thermo regulator in the room farthest from the boiler. Because of highest pressure drop in the pipe, this room is the last one to receive heat, and boiler shuts off when the set temperature is achieved. Therefore, the rooms closest to the boiler are overheated and usually cooled by open windows while the most distant rooms are under heated. Uneven steam distribution and building overheating are he inborn problems of steam heating, especially for single-pipe systems. It was estimated that for every increase of internal temperatures, the space heating cost increased by 3%. In conclusion, an ordinary building's overheating of 14° F. (average 7° F.) corresponds to around 21% more fuel spending.

To decrease the systems pressure drop and achieve uniform steam distribution, large diameters steel pipes with thick threaded walls have been employed since the 1^{st} steam heating system. In addition, reduced steam velocity in these pipes helps to avoid water hammering when steam and condensate are counter flowing. Unfortunately, the usage of large diameter heavy steel piping has caused significant problems:
Steam supply lines should be preheated to a saturated steam temperature before any steam is delivered into the radiator; the line should be kept at this temperature for the duration of the heating cycle. The average 33.3% difference between the boiler's “Gross” and “Net” is the heat it takes to bring the system piping up to the steam temperature. “Net” is the heat available to the radiators after the steam has heated the pipes.
The choice of a radiator is limited to heavy cast iron types; these radiators require a long time to heat up and continue to emit heat into the room long after set temperature reached and the burner is deactivated.
Expensive installation
High heat loss

Back in coal boilers times, naturally induced vacuum systems, which utilized check valves at air vents exits, were invented. While system heated up, these check valves prevented air entry into the system as steam condensed on heavy metal pipes and created a partial vacuum. Negative pressure was supplemented to pressure produced in the boiler, so the total pressure drop for the system increased and steam got into the radiators quicker and more evenly. In 1912, the Eddy system advertisement promised 30-40% of coal pile economy compared to the traditional single-pipe steam system. These first naturally induced vacuum systems worked fine with a near-constant supply of heat from coal but became obsolete after the switch to gas and oil fueled boilers. Gas and oil boilers on/off cycling created a problem if any air was not vented on the first cycle. When the boiler shut off and vacuum was formed, this air expanded, filled the system and impeded the entrance of the vapor into radiators. The production of those special air vent valves, which were equipped with check valves, for single-pipe vacuum systems was discontinued in the 1980^{th} and the whole technology of steam heating with naturally induced vacuum was abandoned.

In pursuit of steam flow control and uniform distribution, in 1906 two pipe systems were introduced, where condensate was returned into a boiler through separate line. Such pipes arrangement allowed placing a control valve on the steam entrance into the radiator and balance the pressure drop throughout the system. Two-pipe systems paved the way for vapor heating systems, which operated on a few ounces of pressure (1 psi=16 ounces), so steam moved quicker from the boiler to the radiators. Steam pipes were sized large enough to keep the pressure drop to a minimum and to produce great fuel economy.

Vapor heating system performance was improved furthermore when combined with either vacuum pumps,—Webster and Bishop-Babcock-Becker systems—or steam jets,—Paul and Moline systems. Here, air and water vapor were sucked through air vent valve on each radiator till steam fill the radiators and shut air vent off. In a system at 10-15 inches of mercury vacuum, steam from the boiler is sucked into the radiators by a vacuum instead of pushing air out. For each radiator differences in pressure drop due to friction in pipes are insignificant compared to total pressure drop, so steam is distributed through radiators more evenly.

Modern vapor vacuum heating systems additionally improved the system efficiency by controlling vapor's temperature through the vacuum level in the system—this all depended on the outside temperature.

Forced air systems entry into the US market shattered the dominance of steam (and hot-water) heating. The superior quality and efficiency of radiant heat was sacrificed for convection heating, all for the sake of a lower installation cost. Few steam heating systems were installed in last fifty years. Still, many buildings in the US and abroad are heated by steam either boilers or district system. Significant savings can be achieved by converting steam systems into a vacuum vapor systems. For new high rise buildings steam is often a valid choice because of the problems associated with long air ducts (for forced air systems) and with high pressure (for hydronic heating systems).

In 1963, heat pipe technology emerged, which utilize latent heat of vaporization for heat transfer and cooling in either vacuum or high pressure, depends on working liquid. This approach, similar to steam heating, demonstrated remarkable density of transferred power and is utilized in many advanced application like NASA spacecrafts, laptops cooling, etc. Heat pipes are generally composed of a tube, closed off on each end, with fluid in it. One end takes in heat and the other expels it. The heat entering the “hot” end of the tube boils the liquid which turns it into a vapor. The vapor expands in volume and travels to the “cold” end where it condenses to a liquid and gives up its heat. The fluid is then returned to the hot end by either gravity or a capillary wick and starts the process again. Heat transfer is limited by the rate at which liquid can flow through the wick, entrainment of liquid in the vapor stream and the rate at which evaporation can take place without excessive temperature differentials in the evaporator section. These factors restrict the transport capacity, heat pipe length and potential usage for a building's heating. An innovative heating system was developed in which radiators includes several heat pipes in order to improve energy transfer into radiator from circulating hot water.

Traditionally, copper has been used to make envelope and wick for water heat pipes at temperatures below about 150° C. In the era of steam heating systems dominance, soldered copper tube lines were not utilized for steam systems for the reason that multiple rapid heating cycles cause leaks in joints. Introduced in 1950^{th}, the Steam Mini-Tube System employed copper tubing for “two-pipe” steam coil—air blower technology but didn't benefits of vacuum system. Modern plumbing employs flared, compression and pressed fittings in order to reliably connect copper tubes without using solder; this technology is barely used because few steam systems were installed in the last fifty years and typical steam heating system retrofit is conversion to hot water.

### SUMMARY OF THE INVENTION

Proposed is a method of preventing water hammering in a single-pipe steam heating system by condensate retention in the radiator during heating cycle and release into the boiler afterward. The technique justifies the usage of noncorrosive lightweight radiators and small diameter tubing. In an air evacuated system, vapor temperature can be maintained in interval from slightly higher then melting point to above boiling point. Noncorrosive materials would also help [symbol] eliminate rust problems.

Also proposed is a method of cycling boiler operation in order to naturally induce and maintain a vacuum in a single-pipe system with periodic condensate return. For this purpose, air vent/vacuum check valve set or combined device is provisioned either on each radiator or on the system air vent line connected to each radiator. In the first heating cycle, the boiler is stopped when thermostat's set temperature is achieved and the most distant radiator is heated from top to bottom. The second condition is essential to verifying that the system is completely purged of air. In a cooled system steam condenses inside and creates a vacuum, but the vacuum check valves will not let air in. Theoretically, system cooling to 90-120° F. can create a vacuum as low as 1-2 inches Hg. Vacuum pump can also be utilized for cold start of leak tight system and for converted steam system with minor leaks.

To take advantage of a vacuum in the system, second and following heating cycles are carried with negative boiler cut off pressure setting or setting lower then vacuum check valve cracking pressure. If required, the air purging cycle can be repeated at boiler cut off pressure setting higher then vacuum check valve cracking pressure. The system is operated by automatic boiler controller in order to optimize working pressure/vacuum sequence.

A universal method is proposed for the conversion of reasonably tight single- and two-pipe systems into a vapor/vacuum system with a naturally induced vacuum.

### BRIEF DESCRIPTION OF THE DRAWINGS

The invention will be more fully understood from the following detailed description taken in conjunction with the accompanying drawings, in which:

FIG. 1 illustrates the schematics of single-pipe vapor/vacuum system with periodic condensate return.

FIG. 2 illustrates the schematics of single-pipe steam/vapor/vacuum heating system with naturally induced vacuum and periodic condensate return.

FIG. 3 illustrates the schematics of large single-pipe steam/vapor/vacuum heating system with naturally induced vacuum and periodic condensate return.

FIG. 4 illustrates the basic radiator design for a single-pipe system with periodic condensate return.

FIG. 5 illustrates the schematics of single- and two-pipe steam heating systems converted into vapor vacuum system with naturally induced vacuum.

FIG. 6 illustrates the schematics of large single- and two-pipe steam heating systems converted into a vapor vacuum system with a naturally induced vacuum.

### DETAILED DESCRIPTION

Certain embodiments will now be described in order to provide an overall understanding of the principles of the structure, function, manufacture, and use of the devices and methods disclosed herein. The features illustrated or described in connection with one embodiment may be combined with the features of other embodiments.

The steam/vacuum system of the present invention can be used in any building and/or dwelling as needed. For the purposes of the descriptions herein, the term “building” will be used to represent any home, dwelling, office building, and commercial building, as well as any other type of building as will be appreciated by one skilled in the art.

In an embodiment, a steam source is provided for producing and introducing steam into the systems described herein. The steam source can be any source known in the art capable of heating water to produce steam, including a boiler system located within the building to be heated or cooled, and/or an external district heating system capable of supplying steam from a location remote to the building.

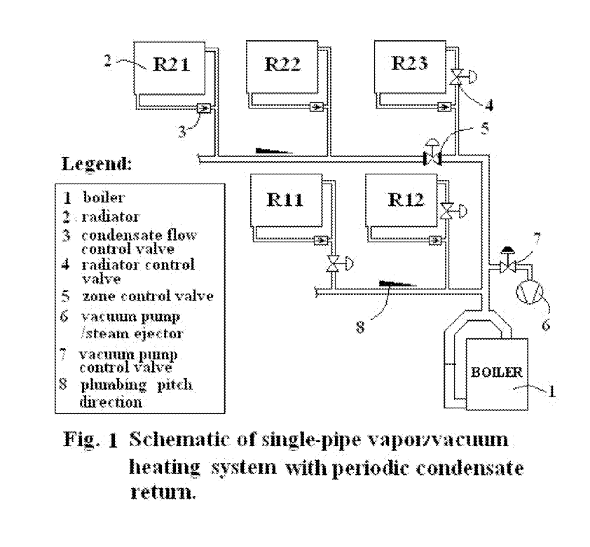

A common principle of steam heating operation assumes continuous condensate return into boiler either through inlet pipe (single-pipe system) or separate line (two-pipe system). As mentioned previously, a single pipe system should employ large diameter pipes in order to avoid water hammering and that requirement subsequently worsens system efficiency, comfort, control, etc. The problem can be resolved by periodic condensate return from radiators after heating cycle—shown in FIG. 1.

Actually, the whole system concept is a branched “heat pipe”, but without a wick and, therefore, a restriction on length. While steam is entering into the upper section of radiator 2, condensate accumulates at the bottom and is returned into the steam supply line through condensate flow control valve 3 after heating cycle. Either a float check valve, or a thermostatic valve, or a zero pressure check valve can control condensate return cycles; bubble tight performance is not crucial. Steam delivery can be regulated by a control valve 4 per radiator base (R11, R12, R23) or by a zone control valve 5 (R21, R22). The system is connected to a vacuum pump 6 through a vacuum pump control valve 7. More conveniently, a steam ejector can be utilized instead, to create an initial vacuum in the system; this makes the system self-sufficient and electricity independent. Proper pluming pitch directions 8 should be provisioned for condensate return into the boiler by gravity. Such an arrangement facilitates periodic condensate returns only after boiler 1 stops. Benefits are as follows:
hot condensate retaining in the radiator during the heating cycle adds heat into the space to be heated
after the boiler shut off, the vapor from the boiler continues to deliver heat into the radiators till the vacuum is formed in a system and equilibrium is established
additional heat from vapor conduit is recovered by flow of condensate into the boiler
turbulent vapor flow regime in smaller diameter tubes ensures that condensate droplets will be carried into the radiator
tubes of smaller diameters can be easily connected with fewer fittings and less leaks
rust free copper (or thermoplastic) tubing can be utilized to trim down boiler rust draining procedure.

Depending on the outside conditions, the temperature of the vapor supplied into the radiators can be adjusted by controlling the system operating interval in the vacuum; the deeper the vacuum the lower the vapor's temperature. Modern copper plumbing is warranted for many years, so the system dependency on the tightness to leaks and, therefore, on electricity for vacuum pump is limited. Polysulfone type tubing can be utilized for steam conduit and flexible Teflon type tubing for end point connections to radiators; both thermoplastics properties exceed the vacuum heating system operational parameters.

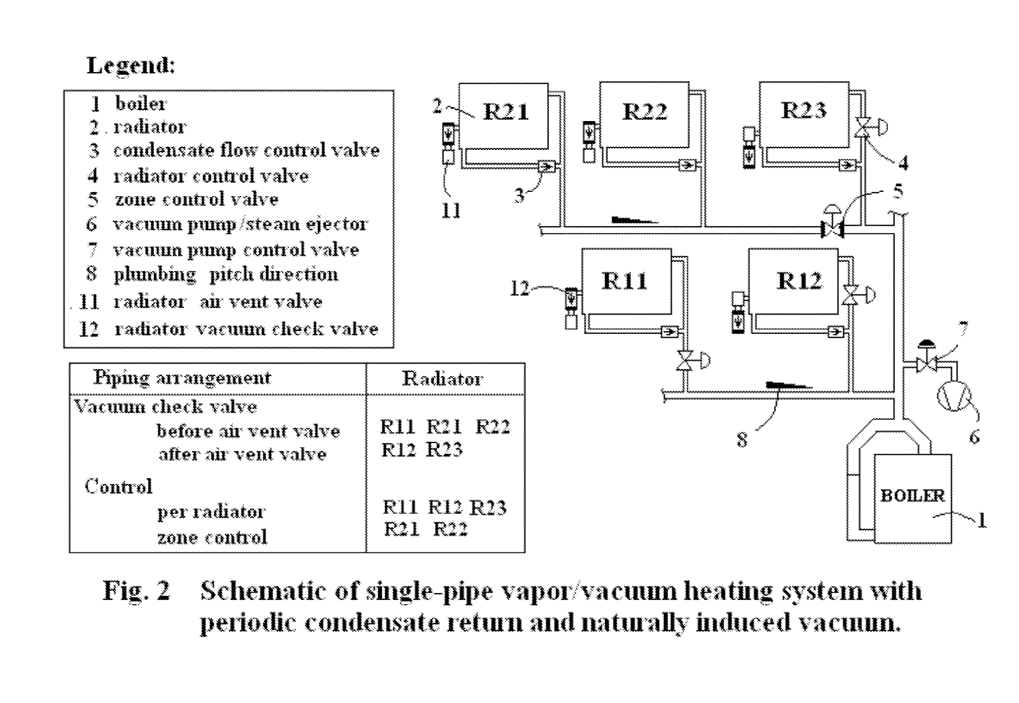

The described vacuum single-pipe system which has periodic condensate return can be readily converted into vapor/vacuum system with naturally induced vacuum by adding check valve 12 to each radiator air vent 11—FIG. 2. The cycling boiler operations include the first heating cycle at a pressure higher then the check valves' cracking pressure, the vacuum formation in a closed cooled system and the following boiler operation set to vacuum or pressure below check valves cracking pressure. The radiator check valve can be installed either before or after the radiator vent valve—R11, R21, R22, and R12, R23, correspondingly. If the vacuum check valve is installed before the radiator air vent valve, the air vent valve is not participating in the second and the following heating cycles; so longer trouble free operation time is expected. The radiator vacuum check valves stay closed as long as the system operates under vacuum. Should any vacuum check valve fail, the corresponding air vent valve will still be on guard to stop the steam from exiting the radiator; air will be sucked in through the faulty vacuum check valve after every heating cycle and the system will start to function like a regular steam heating system.

In warm weather, complete system heating cycle, in order to purge of air and create vacuum, is excessive. Vacuum pump 6 may be provisioned for such conditions. All control valves 4 (radiators R11, R12, R23) and zone control valve 5 (radiators R21, R22) should be open during system purging of air.

In the laboratory setup, a 25 foot long ½″ copper tube delivered steam from a 60,000 Btu/hr capacity boiler to a single 5225 Btu/hr capacity radiator without any water hammering problems. After the boiler shut off, hot vapor continued to heat the radiator for another 30 minutes while the vacuum emerged in the system. For the same steam load, enclosed in PEX tube (cross linked polyethylene) a copper tube is 9-12 times less weight, 3-4 times less in cost and has a 1.5 times less heat loss compared to threaded steel piping within 2″ thick insulation.

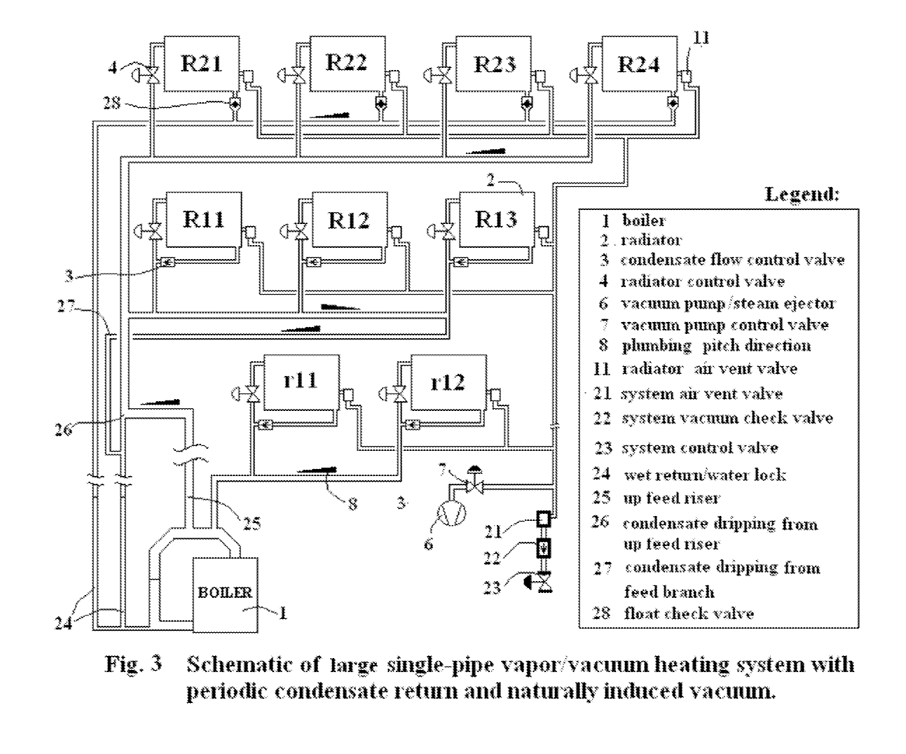

The diagram for a large system is shown in FIG. 3. To protect the system from radiator vacuum check valve failure/leakage, lines from each radiator air vent 11 are connected to the system's only vacuum check valve 22. The on and off control valve 23 is in sync with the boiler operation and can be used instead or in addition to the system vacuum check valve 22 and for routine system pressure leak tests. Similarly, system's air check valve 21 would secure system against radiators' air vent valve failure; faulty valve can easily be traced by monitoring the temperature of the lines.

Due to heat loss in a long supply lines, too much steam may condense on conduit walls. Intermediate condensate drippings into wet return 24 are shown: from up feed riser 25 and from a group of upper floor radiators (R11, R12, R3),—26 and 27, correspondingly. For radiators R21-R24, separate condensate return through the line with a float check valve 28 on each radiator is shown; during heating cycle condensate continuously flows into the boiler wet return 24, like a standard two-pipe design.

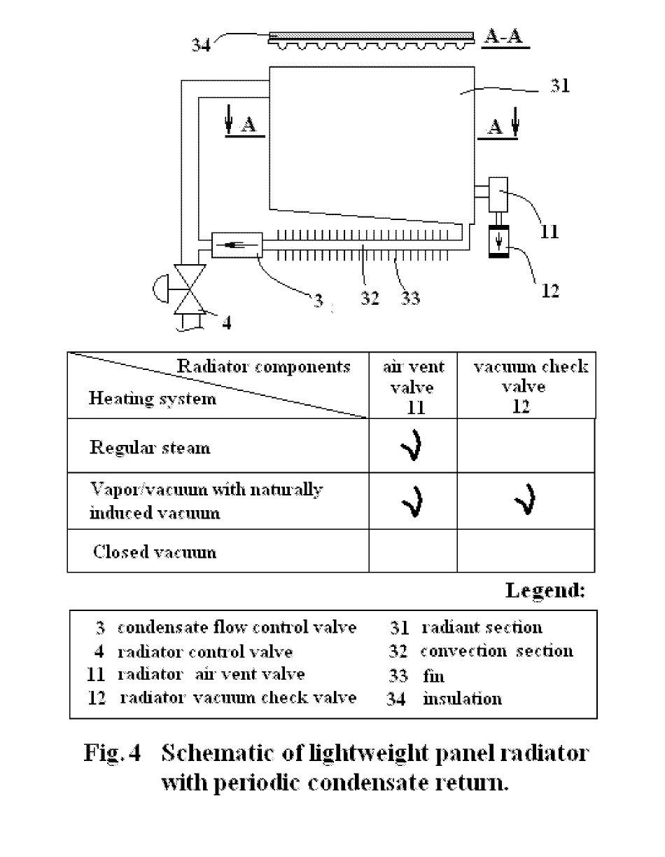

With smaller diameter tubes, lightweight noncorrosive panel radiators can be utilized; the basic design is shown on FIG. 4. The radiator consists of a flat panel radiant section 31 and a convection section 32. The corrugated plate on the radiator's “room side” provide rigid structure and additional surface for radiation, the wall side is covered by insulation 34. Cross-section A-A illustrates an example of the thin radiating section. Fins 33 on convection section 32 enhance the heat extraction from condensate. Steam/vapor delivery into the radiator is controlled manually or automatically by on/off control valve 4, depending on the temperature setting in the heated space. These lightweight radiators can be manufactured inexpensively in a variety of shapes and sizes and conveniently mounted under the windows or on the walls. Because proposed lightweight radiators are heated and cooled significantly quicker, even rooms temperature profile can be achieved to improve comfort and energy efficiency.

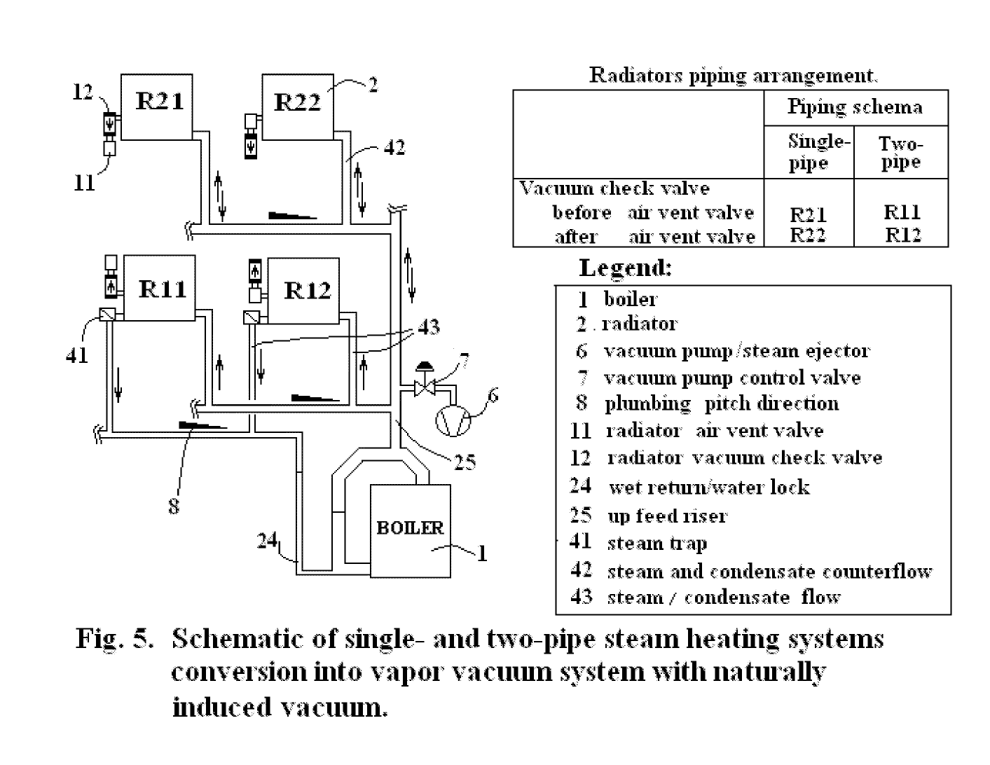

The same combination of cycling boiler operation and the vacuum check valve on each radiator can be utilize to convert existing reasonably leak tight steam heating systems into vapor heating system with a naturally induced vacuum; the better the system is sealed against leaks, the better the expected performance improvement. The diagram is shown on FIG. 5 for single- and two-pipe systems—radiators R21, R22 and R11, R12, correspondingly. For two-pipe system condensate is returned into the boiler wet return 24 through steam traps 41. Piping arrangement table in FIG. 5 explains the differences for each radiator piping. Both single- and two-pipe systems can coexist in a vapor vacuum system. No change is required for existing piping pitch 8 and for steam/vapor/condensate flow directions 42, 43.

Auxiliary vacuum pump 6, connected to the system through control valve 7, can be provisioned to quickly restore vacuum in retrofitted system before heating cycle. Compared to known vacuum systems where high capacity vacuum pump is on and off during every heating cycle, vacuum pump 6 operates only for a short time to restore vacuum in the system. Then boiler is cycled at cut off pressure higher then check valves cracking pressure till thermostat set temperature is achieved; air is completely purged from the system by that time. Vacuum emerges naturally afterwards in idle cooling system. A gas fueled system with milli-volt control, powered by pilot flame, is electricity independent and will maintain the vacuum without vacuum pump in case of power shortage.

By installing a check valve with 1 psi cracking pressure behind each air vent valve, a one hundred years old residential single-pipe steam system with had six radiators was converted into a vacuum system. In test runs, the 24 inch Hg vacuum was produced in 80 minutes after the boiler stop in the first heating cycle. 22, 19 and 17 inch Hg vacuums were retained after 165, 260 and 330 minutes, correspondingly. This timing matches boiler day time cycling frequency in a cold season but system ability to hold vacuum overnight is not sufficient; vacuum pump may be employed to restore vacuum in the morning.

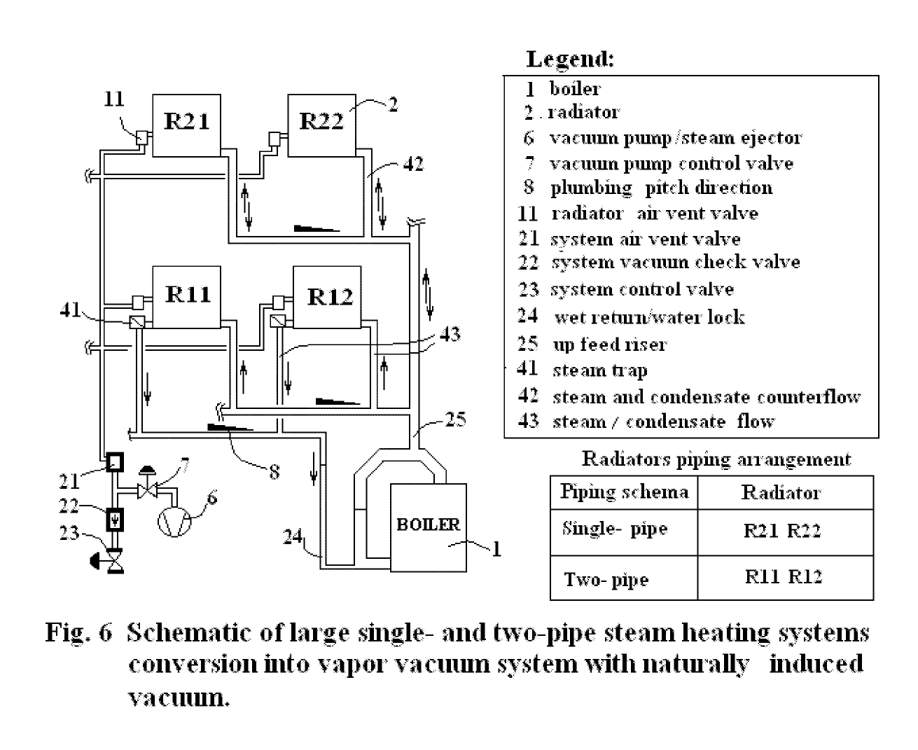

For the conversion of large existing steam systems into vapor/vacuum systems with a naturally induced vacuum, a single system vacuum check valve 22, a system air vent valve 21 and a system control valve 23 can be utilized to improve reliability and leaks detection—shown in FIG. 6.

Without changing the system piping and radiators arrangement, steam from the district grid can be utilized instead of the boiler. The vapor heating system with a naturally induced vacuum can be integrated into a district steam heating system in two ways:
Single loop (direct steam usage). After pressure reduction, district steam is throttled into a vapor heating system with a naturally induced vacuum. The amount of steam is controlled in order to keep the heating system at the desired vacuum level.
Separate loop (indirect steam usage). A coil with high pressure district steam is used inside evaporative heat exchanger to get going the vapor heating system with naturally induced vacuum.

Depending on the particular system specifics, an automatic boiler controller should provide following functionalities:
vacuum pump switch on/off to restore a vacuum in the system
1^{st} boiler heating cycle at switch off pressure slightly higher then vacuum check valve cracking pressure
temperature control of the most distant radiator as an indication of the complete air removal from the system;
monitoring the speed of the vacuum formation in a system
the second and the following heating cycles operation at the boiler cut off pressure below vacuum check valves cracking pressure; the warmer is the weather outside, the less cut off pressure is utilized and the lower is the steam/vapor temperature
low water shut off device to prevent boiler overheating
air vent line temperature monitoring to detect radiators air vent failure.

The boiler controller can be integrated into the building control system in order to optimize operation. One high power boiler can be replaced by a set of smaller capacity boilers fired up alone or in a group to save energy, as well as allow ease maintenance and emergency repairs.

What is claimed is:

1. A building vapor/vacuum heating system with a plurality of radiators comprising of:
a vapor source
a feeder conduit connecting said steam/vapor source to the radiators
a condensate return conduit on each radiator connected to said feeder conduit
a condensate flow control valve on said condensate return conduit for retaining condensate in the radiator during the heating cycle and releasing condensate after the heating cycle
a vacuum pump/steam ejector to evacuate the system
a thermostat in the space to be heated
a vapor source control unit
a pressure in a system sensing means for generating a signal to a vapor source control unit
wherein
an air from the system is evacuated by the vacuum pipe/steam ejector
a vapor source is switched on and off by the control unit within preset pressure/vacuum interval till the temperature in the space to be heated is equal to the thermostat set temperature

2. A heating system as claimed in claim 1 further including per radiator base:
a space to be heated temperature sensing means for generating a signal indicative of difference between the temperature setting and actual temperature in the space to be heated
a control unit, responsive to the signals generated by said space to be heated a temperature sensing means for providing an output signal
a valve on a feeder conduit into the radiator in the space to be heated acting to shut off in response to output signal from control unit

3. A heating system as claimed in claim 2, further including:
a temperature sensing means for outside temperature
wherein
the vapor source cut in/off pressure is adjusted depending on the temperature outside in order to control the vapor's temperature from the vapor source

4. The vacuum heating system of claim 3
wherein
a conduit from vapor source to radiators is made from noncorrosive copper or thermoplastic tubing.

5. The vacuum heating system of claim 4
wherein
a conduit from the vapor source to radiators is enclosed into coaxial thermoplastic tubing for mechanical and heat loss protection.

6. A heating system of claim 4, further including
an air vent valve/vacuum check valve pair on each of said radiators
a temperature sensing means on the farthest radiator
wherein
the first heating cycle is carried out to purge an air from the system at the vapor source cut off pressure setting higher then the vacuum check valves cracking pressure and the vapor source is stopped when the first temperature sensing means signals actual temperature in the space to be heated is equal to the thermostat set temperature, and the second temperature sensing means signal steam entering into the air vent line of the farthest radiator
the second and the following heating cycles are operated at the steam source's cut off pressure setting to a pressure below the vacuum check valve cracking pressure to maintain vacuum
if necessary, an air purging cycle is repeated at the steam/vapor source's cut off pressure higher then the vacuum check valve cracking pressure

7. The heating system of claim 4, further including:
an air vent valves on said radiators
a system air valve/vacuum check valve pair connected to each radiator air vent valve
a system control valve
a temperature sensing means of the farthest radiator
an air vent line from each radiator air check valve to said system's an air valve/vacuum check valve pair
wherein
the first heating cycle is carried out to purge an air from the system at the vapor source's cut off pressure setting higher then the vacuum check valve cracking pressure and the vapor source is stopped when the first temperature sensing means signals actual temperature in the space to be heated is equal to the thermostat set temperature, and the second temperature sensing means signal steam entering into the air vent line of the farthest radiator
the second and the following heating cycles are operated at the steam source's cut off pressure setting pressure below then the vacuum check valve cracking pressure
if necessary, an air purging cycle is repeated at the steam source's cut off pressure higher then the vacuum check valve cracking pressure

8. A method to induce and exercise a vacuum in the existing single- and/or two-pipe steam heating system with a plurality of radiators comprising of:
a vapor source
a feeder conduit connecting said vapor source to the radiators
an air vent valves on said radiators
a steam traps on the condensate return lines from radiators
a vacuum pump/steam ejector to evacuate the system
a system pressure sensor
a thermostat
a vapor source control unit
a pressure in a system sensing means for generating a signal to the vapor source's control unit
a temperature sensing means of the farthest radiator
a vacuum check valves are installed on each radiator air vent line
wherein
air is partially evacuated from the system by a vacuum pump
the first heating cycle is carried out to completely purge an air from the system at the vapor source's cut off pressure setting higher then the vacuum check valve cracking pressure and the vapor source is stopped when the first temperature sensing means signals the actual temperature in the space to be heated equal to the thermostat set temperature, and a the second temperature sensing means signal steam entering into the air vent line of the farthest radiator
the second and the following heating cycles are operated at the steam source's cut off pressure below the vacuum check valve cracking pressure
if necessary, an air purging cycle is repeated at the steam source's cut off pressure higher then the vacuum check valve cracking pressure

9. A method to naturally induce and exercise the vacuum in the existing single- and/or two-pipe steam heating system with a plurality of radiators comprising of:
a vapor source
a feeder conduit connecting said vapor source to the radiators
an air vent valves on said radiators
a steam trap on the condensate return lines from the radiators to the boiler
a vacuum pump/steam ejector
a thermostat
a vapor source control unit
a pressure in the system sensing means for generating a signal to the vapor source's control unit
a temperature sensing means of the farthest radiator
a system's air valve/vacuum check valve pair connected to each radiator air vent valve
a system's control valve
wherein
air is partially evacuated from the system by vacuum pump/steam ejector
the first heating cycle is carried out to completely purge an air from the system at the vapor source's cut off pressure setting higher then the vacuum check valve cracking pressure, and the vapor source is stopped when the first temperature sensing means signals the actual temperature in the space to be heated equal to the thermostat set temperature, and the second temperature sensing means signal steam entering into the air vent line of the farthest radiator
the second and the following heating cycles are operated at the vapor source's cut off pressure below the vacuum check valve cracking pressure
if necessary, an air purging cycle is repeated at the steam source's cut off pressure higher then the vacuum check valve cracking pressure.
